(19) United States
(12) Patent Application Publication
(10) Pub. No.: US 2022/0275253 A1
(43) Pub. Date: Sep. 1, 2022

(54) ADHESIVE COMPOSITIONS

(71) Applicant: PPG Industries Ohio, Inc., Cleveland, OH (US)

(72) Inventors: Loubna Pagnotti, Wexford, PA (US); Masayuki Nakajima, Waxford, PA (US); Hongying Zhou, Allison Park, PA (US); Ying Zhou, Shanghai (CN); Maria S. French, Canfield, OH (US); Kar Tean Tan, Wexford, PA (US); Allison G. Condie, Valencia, PA (US)

(73) Assignee: PPG Industries Ohio, Inc., Cleveland, OH (US)

(21) Appl. No.: 17/631,628

(22) PCT Filed: Jun. 5, 2020
(86) PCT No.: PCT/US2020/036316

§ 371 Date: Jan. 31, 2022

Related U.S. Application Data
(60) Provisional application No. 62/883,389, filed on Aug. 6, 2019.

(51) Int. Cl. C09J 7/38; C09J 163/00; C09J 109/00

(52) U.S. Cl. CPC C09J 7/383; C09J 163/00; C09J 109/00

(57) ABSTRACT

Disclosed herein is an adhesive composition that includes a resin composition and an epoxy-containing compound. The resin composition includes an epoxidized polysulfide and an epoxidized oil. The epoxidized polysulfide is present in the adhesive composition in a weight ratio to the epoxidized oil of 20:1 to 1:1. Also disclosed is the adhesive composition in an at least partially cured state. Also disclosed is a method for treating a substrate comprising applying the adhesive composition to a surface of a substrate; and applying an external energy source to cure the composition. Also disclosed are substrates comprising the adhesive composition in an at least partially cured state.

### CROSS-REFERENCE TO RELATED APPLICATION

This application claims the benefit of U.S. Provisional Application Ser. No. 62/883,389, filed on Aug. 6, 2019, the entire contents of which are incorporated herein by reference.

### GOVERNMENT CONTRACT

This invention was made with Government support under Government Contract No. DE-EE0007760 awarded by the Department of Energy, Office of Energy Efficiency and Renewable Energy. The United States Government has certain rights in this invention.

### FIELD OF THE INVENTION

The present invention relates to compositions, for example adhesive compositions, and to adhesives.

### BACKGROUND OF THE INVENTION

Adhesive compositions are utilized in a wide variety of applications to treat a variety of substrates or to bond together two or more substrate materials.

### SUMMARY OF THE INVENTION

Disclosed herein are adhesive compositions, comprising: a resin composition comprising an epoxidized polysulfide and an epoxidized oil, wherein the epoxidized polysulfide is present in the adhesive composition in a weight ratio to the epoxidized oil of 20:1 to 1:1; and an epoxy-containing compound.

Also disclosed herein are methods of treating a substrate, comprising: contacting at least a portion of a surface of the substrate with a composition comprising: a resin composition comprising an epoxidized polysulfide and an epoxidized oil, wherein the epoxidized polysulfide is present in the adhesive composition in a weight ratio to the epoxidized oil of 20:1 to 1:1; and an epoxy-containing compound.

Also disclosed herein are substrates comprising at least one surface at least partially coated with a layer formed from a composition comprising a resin composition comprising an epoxidized polysulfide and an epoxidized oil, wherein the epoxidized polysulfide is present in the adhesive composition in a weight ratio to the epoxidized oil of 20:1 to 1:1, and an epoxy-containing compound.

Also disclosed herein are articles comprising a first substrate and a second substrate and a composition positioned between the first and second substrates, the composition comprising: a resin composition comprising an epoxidized polysulfide and an epoxidized oil, wherein the epoxidized polysulfide is present in the adhesive composition in a weight ratio to the epoxidized oil of 20:1 to 1:1; and an epoxy-containing compound.

### BRIEF DESCRIPTION OF THE DRAWING

FIG. 1 is a schematic of a lap shear joint used in the Examples. All dimensions are in millimeters (mm).

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “an” epoxy-containing component and “a” curing agent, a combination (i.e., a plurality) of these components can be used.

In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

As used herein, the terms “on,” “onto,” “applied on,” “applied onto,” “formed on,” “deposited on,” “deposited onto,” mean formed, overlaid, deposited, or provided on but not necessarily in contact with the surface. For example, a coating composition “applied onto” a substrate does not preclude the presence of one or more other intervening coating layers of the same or different composition located between the coating composition and the substrate.

As used herein, the term “structural adhesive” means an adhesive producing a load-bearing joint having both a lap shear strength of greater than 10 MPa a measured according to SAE J1523 as measured by an INSTRON 5567 machine in tensile mode with 45.1 mm of aluminum substrate in each grip and a nominal pull rate of 13 mm per minute.

As defined herein, a “1K” or “one-component” coating composition, is a composition in which all of the ingredients may be premixed and stored and wherein the reactive components do not readily react at ambient or slightly thermal conditions, but instead only react upon activation by an external energy source. In the absence of activation from the external energy source, the composition will remain largely unreacted (maintaining sufficient workability in the uncured state and greater than 50% of the initial lap shear strength of the composition in the cured state after storage at 25° C. in the uncured state for 8 months). External energy sources that may be used to promote the curing reaction (i.e., the crosslinking of the epoxy component and the curing agent) include, for example, radiation (i.e., actinic radiation) and/or heat.

As further defined herein, ambient conditions generally refer to room temperature and humidity conditions or temperature and humidity conditions that are typically found in the area in which the adhesive is being applied to a substrate, e.g., at 10° C. to 40° C. and 5% to 80% relative humidity, while slightly thermal conditions are temperatures that are slightly above ambient temperature but are generally below the curing temperature for the coating composition (i.e., in other words, at temperatures and humidity conditions below which the reactive components will readily react and cure, e.g., >40° C. and less than 100° C. at 5% to 80% relative humidity).

As used herein, “Mw” refers to the weight average molecular weight and means the theoretical value as determined by Gel Permeation Chromatography using Waters 2695 separation module with a Waters 410 differential refractometer (RI detector) and polystyrene standards. Tetrahydrofuran (THF) used as the eluent at a flow rate of 1 ml min⁻¹, and two PL Gel Mixed C columns used for separation.

As used herein, the term “curing agent” means any reactive material that can be added to a composition to promote the curing of the composition (e.g., curing of a polymer). The term “reactive” when used with respect to the curing agent means capable of chemical reactions and includes any level of reaction from partial to complete reaction of a reactant. In some examples, a curing agent may function as a reactive catalyst by decreasing the activation energy of a chemical reaction or may be reactive when it provides for cross-linking or gelling of a polymer.

As used herein, the term “cure”, “cured” or similar terms, as used in connection with the composition described herein, means that at least a portion of the components that form the composition are crosslinked to form an adhesive coating, film, layer, or bond. Additionally, curing of the composition refers to subjecting said composition to curing conditions (e.g., elevated temperature, lowered activation energy) leading to the reaction of the reactive functional groups of the components of the composition, and resulting in the crosslinking of the components of the composition and formation of an at least partially cured or gelled coating. As used herein, the term “at least partially cured” with respect to a coating refers to a coating formed by subjecting the composition to curing conditions such that a chemical reaction of at least a portion of the reactive groups of the components of the composition occurs to form a coating, film, layer, or bond. A coating composition may be considered to be “at least partially cured” if it has a lap shear strength of at least 10 MPaa measured according to SAE J1523 as measured by an INSTRON 5567 machine in tensile mode with 45.1 mm of aluminum substrate in each grip. The coating composition may also be subjected to curing conditions such that a substantially complete cure is attained and wherein further curing results in no significant further improvement in the coating properties such as, for example, increased lap shear performance.

As used herein, the term “accelerator” means a substance that increases the rate or decreases the activation energy of a chemical reaction. An accelerator may be either a “catalyst,” that is, without itself undergoing any permanent chemical change, or may be reactive, that is, capable of chemical reactions and includes any level of reaction from partial to complete reaction of a reactant.

As used herein, the terms “latent” or “blocked” or “encapsulated”, when used with respect to a curing agent or an accelerator, means a molecule or a compound that is activated by an external energy source prior to reacting (i.e., crosslinking) or having a catalytic effect, as the case may be. For example, an accelerator may be in the form of a solid at room temperature and have no catalytic effect until it is heated and melts, or the latent accelerator may be reversibly reacted with a second compound that prevents any catalytic effect until the reversible reaction is reversed by the application of heat and the second compound is removed, freeing the accelerator to catalyze reactions.

As used herein, unless indicated otherwise, the term “substantially free” means that a particular material is not purposefully added to a mixture or composition, respectively, and is only present as an impurity in a trace amount of less than 5% by weight based on a total weight of the mixture or composition, respectively. As used herein, unless indicated otherwise, the term “essentially free” means that a particular material is only present in an amount of less than 2% by weight based on a total weight of the mixture or composition, respectively. As used herein, unless indicated otherwise, the term “completely free” means that a mixture or composition, respectively, does not comprise a particular material, i.e., the mixture or composition comprises 0% by weight of such material.

As used herein, the term “glass transition temperature” (“Tg”) refers to the temperature at which an amorphous material, such as glass or a high polymer, changes from a brittle vitreous state to a plastic state or from a plastic state to a brittle vitreous state.

The present invention is directed to a one-component adhesive composition comprising, or consisting essentially of, or consisting of: a resin composition comprising an epoxidized polysulfide and an epoxidized oil, wherein the epoxidized polysulfide is present in the adhesive composition in a weight ratio to the epoxidized oil of 20:1 to 1:1; and an epoxy-containing compound. The compositions may be one-component adhesive compositions that provide sufficient bond strength and are easy to apply for use in bonding together substrate materials.

The compositions of the present invention comprise a sulfur-containing polymer, which, as used herein, refers to a polymer that contains multiple sulfide groups, i.e., —S—, in the polymer backbone and/or in the terminal or pendant positions on the polymer chain.

As used herein, the term “polysulfide” refers to a sulfur-containing polymer that contains one or more disulfide linkages, i.e., —[S—S]— linkages, in the polymer backbone and/or in the terminal or pendant positions on the polymer chain. Often, the polysulfide polymer will have two or more sulfur-sulfur linkages. Suitable polysulfides include, for example, those that are commercially available from Akzo Nobel under the name THIOPLAST. THIOPLAST products are available in a wide range of molecular weights ranging, for example, from less than 1100 to over 8000, with molecular weight being the average molecular weight in grams per mole. In some cases, the polysulfide has a number average molecular weight of 1,000 to 4,000. The crosslink density of these products also varies, depending on the amount of crosslinking agent, such as trichloropropane, used. For example, crosslink densities often range from 0 to 5 mol %, such as 0.2 to 5 mol %. The “—SH” content, i.e., mercaptan content, of these products can also vary. The mercaptan content and molecular weight of the polysulfide can affect the cure speed of the polymer, with cure speed increasing with molecular weight.

Optionally, according to the present invention, the composition may comprise a mixture of two or more polysulfides.

As used herein, the term “epoxidized polysulfide” refers to a sulfur-containing polymer that contains at least one epoxy group in the terminal and/or pendant positions. Suitable epoxy resins for the epoxy group include multifunctional epoxy resins such as of the bisphenol A-type, bisphenol F-type, phenol novolac-type and cresol novolac-type epoxy resins. The sulfur-containing polymer may be an epoxidized polysulfide that is a block copolymer of a polysulfide and an epoxy resin. An example of an epoxidized polysulfide is commercially available from Toray International America Inc. under the name FLEP such as FLEP-60 which is a block copolymer of THIOKOL™ LP and bisphenol F-type epoxy resin. FLEP-60 has a 35 weight percent THIOKOL™ LP content and a 50 to 60 weight percent bisphenol F content. As used herein, the term “block copolymer” refers to a copolymer formed when the two monomers cluster together and form blocks of repeating units.

The epoxidized polysulfide may be cured with a curing agent that is reactive with the epoxy groups of the sulfur-containing polymer.

The epoxidized polysulfide may be present in the adhesive composition in an amount of at least 10 percent by weight based on total weight of the adhesive composition, such as at least 15 percent by weight, and may be present in the adhesive composition in an amount of no more than 50 percent by weight based on total weight of the adhesive composition, such as no more than 30 percent by weight. The epoxidized polysulfide may be present in the adhesive composition in an amount of 10 percent by weight to 50 percent by weight based on total weight of the adhesive composition, such as 15 percent by weight to 30 percent by weight.

The resin composition of the adhesive composition according to the invention contains an epoxidized oil, such an epoxidized natural oil. As used herein, the term “epoxidized oil” refers to a linear or a branched hydrocarbon chain having polyepoxide functionality.

Examples of natural oils include castor oil, soybean oil, linseed oil and palm oil. An example of an epoxidized castor oil is castor oil-polyglycidyl ether, such as castor oil-triglycidyl ether. An example of an epoxidized castor oil is commercially available from Hexion Specialty Chemicals, Inc. under the name Heloxy™ Modifier 505. Another example of an epoxidized castor oil is Erisys GE-35 available from CVC, having a mixture of isomers with the following general structure:

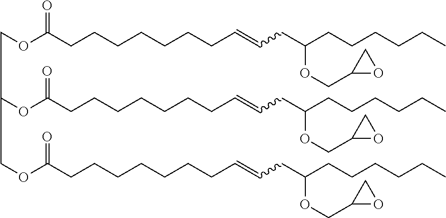 [SMILES: CCCCCCC(CC=CCCCCCCCC(=O)OCC(COC(=O)CCCCCCCC=CCC(CCCCCC)OCC1CO1)OC(=O)CCCCCCCC=CCC(CCCCCC)OCC1CO1)OCC1CO1]

An example of an epoxidized soybean oil is commercially available from The Chemical Company under the name ChemFlexx Epoxidized Soybean Oil. An example of an epoxidized linseed oil is commercially available from Arkema Group under the name Vicoflex® 7190. Epoxidized palm oil is described in the article “Investigation of Epoxidize Palm Oils as Green Processing Aids and Activators in Rubber Composites,” of Lee, DongJu et al., Int'l J. Polymer Science, Vol. 2019, Article ID 2152408 (2019).

The epoxidized oil may be present in the adhesive composition in an amount of at least 0.5 percent by weight based on total weight of the adhesive composition, such as at least 2 percent by weight, such as at least 5 percent by weight, and may be present in the adhesive composition in an amount of no more than 25 percent by weight based on total weight of the adhesive composition, such as no more than 7.5 percent by weight. The epoxidized oil may be present in the adhesive composition in an amount of 0.5 percent by weight to 25 percent by weight based on total weight of the adhesive composition, such as 2 percent by weight to 30 percent by weight.

The adhesive composition may comprise an epoxy-containing component. Suitable epoxy compounds that may be used include monoepoxides, polyepoxides, or combinations thereof.

Suitable monoepoxides that may be used include monoglycidyl ethers of alcohols and phenols, such as phenyl glycidyl ether, n-butyl glycidyl ether, cresyl glycidyl ether, isopropyl glycidyl ether, glycidyl versatate, for example, CARDURA E available from Shell Chemical Co., and glycidyl esters of monocarboxylic acids such as glycidyl neodecanoate, and mixtures of any of the foregoing.

Useful epoxy-containing components that can be used include polyepoxides (having an epoxy functionality greater than 1), epoxy adducts, or combinations thereof. Suitable polyepoxides include polyglycidyl ethers of Bisphenol A, such as Epon® 828 and 1001 epoxy resins, and Bisphenol F polyepoxides, such as Epon® 862, which are commercially available from Hexion Specialty Chemicals, Inc. Other useful polyepoxides include polyglycidyl ethers of polyhydric alcohols, polyglycidyl esters of polycarboxylic acids, polyepoxides that are derived from the epoxidation of an olefinically unsaturated alicyclic compound, polyepoxides containing oxyalkylene groups in the epoxy molecule, and epoxy novolac resins. Still other non-limiting epoxy components include epoxidized Bisphenol A novolacs, epoxidized phenolic novolacs, epoxidized cresylic novolac, isosorbide diglycidyl ether, triglycidyl p-aminophenol, and triglycidyl p-aminophenol bismaleimide, triglycidyl isocyanurate, tetraglycidyl 4,4′-diaminodiphenylmethane, and tetraglycidyl 4,4′-diaminodiphenylsulphone. The epoxy-containing component may also comprise a carboxyl-terminated butadiene-acrylonitrile copolymer modified epoxy-containing compound. The epoxy-containing compound may also comprise an epoxidized oil such as an epoxidized natural oil such as epoxidized castor oil. The epoxy-containing compound may also comprise an epoxy-containing acrylic, such as glycidyl methacrylate.

The epoxy-containing component may comprise an epoxy-adduct. The composition may comprise one or more epoxy-adducts. As used herein, the term “epoxy-adduct” refers to a reaction product comprising the residue of an epoxy and at least one other compound that does not include an epoxide functional group. For example, the epoxy-adduct may comprise the reaction product of reactants comprising an epoxy, a polyol, and an anhydride.

The epoxy used to form the epoxy-adduct may comprise any of the epoxy-containing compounds listed above that may be included in the composition.

The polyol used to form the epoxy-adduct may include diols, triols, tetraols and higher functional polyols. Combinations of such polyols may also be used. The polyols may be based on a polyether chain derived from ethylene glycol, propylene glycol, butylene glycol, hexylene glycol and the like as well as mixtures thereof. The polyol may also be based on a polyester chain derived from ring opening polymerization of caprolactone (referred to as polycaprolactone-based polyols hereinafter). Suitable polyols may also include polyether polyols, polyurethane polyols, polyurea polyols, acrylic polyols, polyester polyols, polybutadiene polyols, hydrogenated polybutadiene polyols, polycarbonate polyols, polysiloxane polyols, and combinations thereof. Polyamines corresponding to polyols may also be used, and in this case, amides instead of carboxylic esters will be formed with the anhydrides.

The polyol may comprise a polycaprolactone-based polyol. The polycaprolactone-based polyols may comprise diols, triols or tetraols terminated with primary hydroxyl groups. Commercially available polycaprolactone-based polyols include those sold under the trade name Capa™ from Perstorp Group, such as, for example, Capa 2054, Capa 2077A, Capa 2085, Capa 2205, Capa 3031, Capa 3050, Capa 3091 and Capa 4101.

The polyol may comprise a polytetrahydrofuran-based polyol. The polytetrahydrofuran-based polyols may comprise diols, triols or tetraols terminated with primary hydroxyl groups. Commercially available polytetrahydrofuran-based polyols include those sold under the trade name Terathane®, such as Terathane® PTMEG 250 and Terathane® PTMEG 650 which are blends of linear diols in which the hydroxyl groups are separated by repeating tetramethylene ether groups, available from Invista. In addition, polyols based on dimer diols sold under the trade names Pripol®, Solvermol™ and Empol®, available from Cognis Corporation, or bio-based polyols, such as the tetrafunctional polyol Agrol 4.0, available from BioBased Technologies, may also be utilized.

The anhydride that may be used to form the epoxy-adduct may comprise any suitable acid anhydride known in the art. For example, the anhydride may comprise hexahydrophthalic anhydride and its derivatives (e.g., methyl hexahydrophthalic anhydride); phthalic anhydride and its derivatives (e.g., methyl phthalic anhydride); maleic anhydride; succinic anhydride; trimelletic anhydride; pyromelletic dianhydride (PMDA); 3,3′,4,4′-oxydiphthalic dianhydride (ODPA); 3,3′,4,4′-benzopherone tetracarboxylic dianhydride (BTDA); and 4,4′-diphthalic (hexafluoroisopropylidene) anhydride (6FDA).

The epoxy-adduct may comprise a diol, a monoanhydride, and a diepoxy compound, wherein the mole ratio of diol, monoanhydride, and diepoxy compounds in the epoxy-adduct may vary from 0.5:0.8:1.0 to 0.5:1.0:6.0.

The epoxy-adduct may comprise a triol, a monoanhydride, and a diepoxy compound, wherein the mole ratio of triol, monoanhydride, and diepoxy compounds in the epoxy-adduct may vary from 0.5:0.8:1.0 to 0.5:1.0:6.0.

The epoxy-adduct may comprise a tetraol, a monoanhydride, and a diepoxy compound, wherein the mole ratio of tetraol, monoanhydride, and diepoxy compounds in the epoxy-adduct may vary from 0.5:0.8:1.0 to 0.5:1.0:6.0.

Other suitable epoxy-containing components include epoxy-adducts such as epoxy polyesters formed as the reaction product of reactants comprising an epoxy-containing compound, a polyol and an anhydride, as described in U.S. Pat. No. 8,796,361, col. 3, line 42 through col. 4, line 65, the cited portion of which is incorporated herein by reference.

The composition may further include elastomeric particles. The elastomeric particles may be added to the composition as a solid powder or may be predispersed in a liquid medium such as the epoxy-containing component of the present invention. As used herein, “elastomeric particles” refers to particles comprised of one or more materials having at least one glass transition temperature (Tg) of greater than −150° C. and less than 30° C. Tg values as used herein with respect to the elastomeric particles means the peak in the tan delta curve generated by Dynamic Mechanical Analysis (DMA) test using a strain of 0.01%, a frequency of 6.28 Rad/s, and a temperature ramp of 2° C./minute using a TA Instruments RSA3 Dynamic Mechanical Analyzer or other similar equipment. The elastomeric particles may be phase-separated from the epoxy in the epoxy-containing component. As used herein, the term “phase-separated” means forming a discrete domain within a matrix of the epoxy-containing component.

The elastomeric particles may have a core/shell structure. Suitable core-shell elastomeric particles may be comprised of an acrylic shell and an elastomeric core. The core may comprise natural or synthetic rubbers, polybutadiene, styrene-butadiene, polyisoprene, chloroprene, acrylonitrile butadiene, butyl rubber, polysiloxane, polysulfide, ethylene-vinyl acetate, fluoroelastomer, polyolefin, hydronated styrene-butadiene, or combinations thereof.

Exemplary non-limiting commercial core-shell elastomeric particle products using poly(butadiene) rubber particles that may be utilized in the adhesive composition of the present invention include core-shell poly(butadiene) rubber powder (commercially available as PARALOID™ EXL 2650A from Dow Chemical), a core-shell poly(butadiene) rubber dispersion (25% core-shell rubber by weight) in bisphenol F diglycidyl ether (commercially available as Kane Ace MX 136), a core-shell poly(butadiene) rubber dispersion (33% core-shell rubber by weight) in Epon® 828 (commercially available as Kane Ace MX 153), a core-shell poly(butadiene) rubber dispersion (33% core-shell rubber by weight) in Epiclon® EXA-835LV (commercially available as Kane Ace MX 139), a core-shell poly(butadiene) rubber dispersion (37% core-shell rubber by weight) in bisphenol A diglycidyl ether (commercially available as Kane Ace MX 257), and a core-shell poly(butadiene) rubber dispersion (37% core-shell rubber by weight) in Epon® 863 (commercially available as Kane Ace MX 267), each available from Kaneka Texas Corporation, a siloxane rubber dispersion in bisphenol F diglydicyl ether (commercially available as Kane Ace MX-960), and acrylic rubber dispersions.

Exemplary non-limiting commercial core-shell elastomeric particle products using styrene-butadiene rubber particles that may be utilized in the adhesive composition include a core-shell styrene-butadiene rubber powder (commercially available as CLEARSTRENGTH® XT100 from Arkema), core-shell styrene-butadiene rubber powder (commercially available as PARALOID™ EXL 2650J), a core-shell styrene-butadiene rubber dispersion (33% core-shell rubber by weight) in bisphenol A diglycidyl ether (commercially available as Fortegra™ 352 from Olin™), core-shell styrene-butadiene rubber dispersion (33% rubber by weight) in low viscosity bisphenol A diglycidyl ether (commercially available as Kane Ace MX 113), a core-shell styrene-butadiene rubber dispersion (25% core-shell rubber by weight) in bisphenol A diglycidyl ether (commercially available as Kane Ace MX 125), a core-shell styrene-butadiene rubber dispersion (25% core-shell rubber by weight) in bisphenol F diglycidyl ether (commercially available as Kane Ace MX 135), a core-shell styrene-butadiene rubber dispersion (25% core-shell rubber by weight) in D.E.N.™-438 phenolic novolac epoxy (commercially available as Kane Ace MX 215), a core-shell styrene-butadiene rubber dispersion (25% core-shell rubber by weight) in Araldite® MY-721 multi-functional epoxy (commercially available as Kane Ace MX 416), a core-shell styrene-butadiene rubber dispersion (25% core-shell rubber by weight) in MY-0510 multi-functional epoxy (commercially available as Kane Ace MX 451), a core-shell styrene-butadiene rubber dispersion (25% core-shell rubber by weight) in Syna Epoxy 21 Cyclo-aliphatic Epoxy from Synasia (commercially available as Kane Ace MX 551), and a core-shell styrene-butadiene rubber dispersion (25% core-shell rubber by weight) in polypropylene glycol (MW 400) (commercially available as Kane Ace MX 715), each available from Kaneka Texas Corporation.

Exemplary non-limiting commercial core-shell elastomeric particle products using polysiloxane rubber particles that may be utilized in the adhesive composition of the present invention include a core-shell polysiloxane rubber powder (commercially available as GENIOPERL® P52 from Wacker), a core-shell polysiloxane rubber dispersion (40% core-shell rubber by weight) in bisphenol A diglycidyl ether (commercially available as ALBIDUIR® EP2240A from Evonick), a core-shell polysiloxane rubber dispersion (25% core-shell rubber by weight) in jER™828 (commercially available as Kane Ace MX 960), a core-shell polysiloxane rubber dispersion (25% core-shell rubber by weight) in Epon® 863 (commercially available as Kane Ace MX 965) each available from Kaneka Texas Corporation.

The elastomeric particles may be present in the in the adhesive composition in an amount of at least 0.5 percent by weight based on the total composition weight, such as at least 10 percent, and in some cases may be present in the composition in an amount of no more than 80 percent by weight based on the total composition weight, such as no more than 50 percent. According to the present invention, the elastomeric particles may be present in the composition in an amount of from greater than 0.5 percent by weight to 80 percent by weight based on the total composition weight, such as 10 percent by weight to 50 percent by weight.

According to the present invention, the epoxy-containing component (including where the epoxy-containing component includes one or more epoxies and/or elastomeric particles dispersed in an epoxy) may be present in the composition in an amount of at least 25 percent by weight based on the total weight of the adhesive composition, such as at least 50 percent by weight, and in some cases may be present in the adhesive composition in an amount of no more than 89.5 percent by weight based on the total weight of the adhesive composition, such as no more than 75 percent by weight. According to the present invention, the epoxy-containing component may be present in the adhesive composition in an amount of 25 percent by weight to 89.5 percent by weight based on total weight of the adhesive composition, such as 50 percent by weight to 75 percent by weight. Some additional epoxy may be present in the adhesive composition in addition to the epoxy-containing component. For example, additional epoxy may derive from excess or unreacted epoxy in the epoxidized polysulfide and/or the epoxidized oil.

The epoxidized polysulfide may be present in the composition in an amount such that the weight ratio of epoxidized polysulfide to the epoxidized oil may be no more than 20:1, such as no more than 15:1, such as no more than 10:1, such as no more than 7.5:1. The epoxidized polysulfide may be present in the composition in an amount such that the weight ratio of epoxidized polysulfide to the epoxidized oil may be 20:1 to 1:1, such as 15:1 to 1:1, such as 10:1 to 1:1, such as 7.5:1 to 1:1.

The adhesive composition of the present invention optionally may further comprise a latent curing agent and/or a latent accelerator. The latent curing agent and/or accelerator may be encapsulated, non-encapsulated, blocked, or combinations thereof. The latent curing agent may be activatable by an external energy source.

In examples, the latent curing agent may comprise, or consist essentially of, or consist of, a guanidine. It will be understood that “guanidine,” as used herein, refers to guanidine and derivatives thereof. For example, the curing agent that may be used includes guanidines, substituted guanidines, substituted ureas, melamine resins, guanamine derivatives, heat-activated cyclic tertiary amines, aromatic amines and/or mixtures thereof. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and, more especially, cyanoguanidine (dicyandiamide, e.g. Dyhard® available from AlzChem). Representatives of suitable guanamine derivatives which may be mentioned are alkylated benzoguanamine resins, benzoguanamine resins or methoxymethylethoxymethylbenzoguanamine.

For example, the guanidine may comprise a compound, moiety, and/or residue having the following general structure:

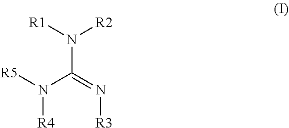

wherein each of R1, R2, R3, R4, and R5 (i.e., substituents of structure (I)) comprise hydrogen, (cyclo)alkyl, aryl, aromatic, organometallic, a polymeric structure, or together can form a cycloalkyl, aryl, or an aromatic structure, and wherein R1, R2, R3, R4, and R5 may be the same or different. As used herein, “(cyclo)alkyl” refers to both alkyl and cycloalkyl. When any of the R groups “together can form a (cyclo)alkyl, aryl, and/or aromatic group”, it is meant that any two adjacent R groups are connected to form a cyclic moiety, such as the rings in structures (II)-(V) below.

It will be appreciated that the double bond between the carbon atom and the nitrogen atom that is depicted in structure (I) may be located between the carbon atom and another nitrogen atom of structure (I). Accordingly, the various substituents of structure (I) may be attached to different nitrogen atoms depending on where the double bond is located within the structure.

The guanidine may comprise a cyclic guanidine such as a guanidine of structure (I) wherein two or more R groups of structure (I) together form one or more rings. In other words, the cyclic guanidine may comprise ≥1 ring(s). For example, the cyclic guanidine may either be a monocyclic guanidine (1 ring) such as depicted in structures (II) and (III) below, or the cyclic guanidine may be bicyclic or polycyclic guanidine (≥2 rings) such as depicted in structures (IV) and (V) below.

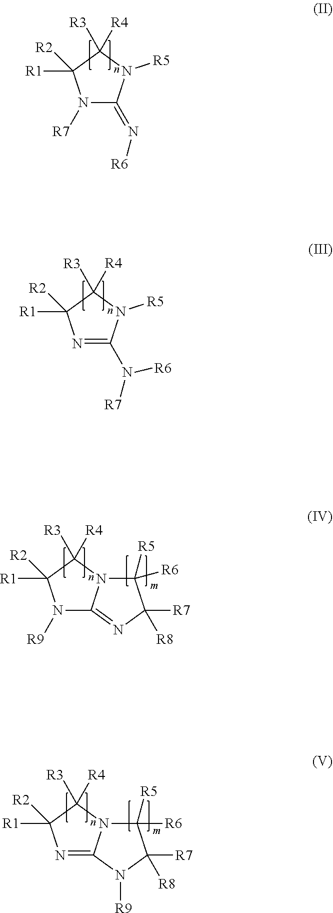

Each substituent of structures (II) and/or (III), R1-R7, may comprise hydrogen, (cyclo)alkyl, aryl, aromatic, organometallic, a polymeric structure, or together can form a cycloalkyl, aryl, or an aromatic structure, and wherein R1-R7 may be the same or different. Similarly, each substituent of structures (IV) and (V), R1-R9, may be hydrogen, alkyl, aryl, aromatic, organometallic, a polymeric structure, or together can form a cycloalkyl, aryl, or an aromatic structure, and wherein R1-R9 may be the same or different. Moreover, in some examples of structures (II) and/or (III), certain combinations of R1-R7 may be part of the same ring structure. For example, R1 and R7 of structure (II) may form part of a single ring structure. Moreover, it will be understood that any combination of substituents (R1-R7 of structures (II) and/or (III) as well as R1-R9 of structures (IV) and/or (V)) may be chosen so long as the substituents do not substantially interfere with the catalytic activity of the cyclic guanidine.

Each ring in the cyclic guanidine may be comprised of ≥5 members. For example, the cyclic guanidine may comprise a 5-member ring, a 6-member ring, and/or a 7-member ring. As used herein, the term “member” refers to an atom located in a ring structure. Accordingly, a 5-member ring will have 5 atoms in the ring structure (“n” and/or “m”=1 in structures (II)-(V)), a 6-member ring will have 6 atoms in the ring structure (“n” and/or “m”=2 in structures (II)-(V)), and a 7-member ring will have 7 atoms in the ring structure (“n” and/or “m”=3 in structures (II)-(V)). It will be appreciated that if the cyclic guanidine is comprised of ≥2 rings (e.g., structures (IV) and (V)), the number of members in each ring of the cyclic guanidine can either be the same or different. For example, one ring may be a 5-member ring while the other ring may be a 6-member ring. If the cyclic guanidine is comprised of ≥3 rings, then in addition to the combinations cited in the preceding sentence, the number of members in a first ring of the cyclic guanidine may be different from the number of members in any other ring of the cyclic guanidine.

It will also be understood that the nitrogen atoms of structures (II)-(V) may further have additional atoms attached thereto. Moreover, the cyclic guanidine may either be substituted or unsubstituted. For example, as used herein in conjunction with the cyclic guanidine, the term “substituted” refers to a cyclic guanidine wherein R5, R6, and/or R7 of structures (II) and/or (III) and/or R9 of structures (IV) and/or (V) is not hydrogen. As used herein in conjunction with the cyclic guanidine, the term “unsubstituted” refers to a cyclic guanidine wherein R1-R7 of structures (II) and/or (III) and/or R1-R9 of structures (IV) and/or (V) are hydrogen.

The cyclic guanidine may comprise a bicyclic guanidine, and the bicyclic guanidine may comprise 1,5,7-triazabicyclo[4.4.0]dec-5-ene (“TBD” or “BCG”).

The curing agent may be present in the adhesive composition in an amount of at least 1 percent by weight based on total weight of the adhesive composition, such as at least 5 percent by weight, and may be present in the adhesive composition in an amount of no more than 20 percent by weight based on total weight of the adhesive composition, such as no more than 10 percent by weight. The curing agent may be present in the adhesive composition in an amount of 1 percent by weight to 20 percent by weight based on total weight of the adhesive composition, such as 5 percent by weight to 10 percent by weight.

The composition also may comprise a accelerator. Useful accelerators may comprise amidoamine or polyamide catalysts, such as, for example, one of the Ancamide® products available from Air Products, amine, dihydrazide, imidazole, or dicyandiamide adducts and complexes, such as, for example, one of the Ajicure® products available from Ajinomoto Fine Techno Company, 3,4-dichlorophenyl-N,N-dimethylurea (A.K.A. Diuron) available from Alz Chem, or combinations thereof.

Useful imidazoles include, as examples, the following:

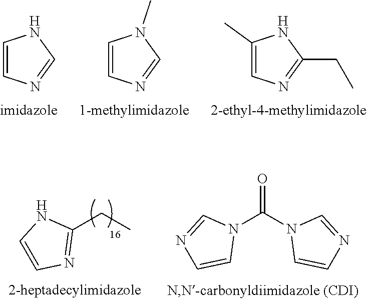

The accelerator, if present at all, may be present in the adhesive composition in an amount of no more than 5 percent by weight based on total weight of the adhesive composition, such as no more than 2 percent by weight. The accelerator, if present at all, may be present in the adhesive composition in an amount of 0.05 percent by weight to 5 percent by weight based on total weight of the adhesive composition, such as 0.5 percent by weight to 2 percent by weight.

According to the present invention, reinforcement fillers may optionally be added to the adhesive composition. Useful reinforcement fillers that may be introduced to the adhesive composition of the present invention to provide improved mechanical materials such as fiberglass, fibrous titanium dioxide, whisker type calcium carbonate (aragonite), and carbon fiber (which includes graphite and carbon nanotubes). In addition, fiber glass ground to 5 microns or wider and to 50 microns or longer may also provide additional tensile strength.

According to the present invention, organic and/or inorganic fillers, such as those that are substantially spherical, may optionally be added to the adhesive composition. Useful organic fillers that may be introduced include cellulose, starch, and acrylic. Useful inorganic fillers that may be introduced include borosilicate, aluminosilicate, calcium inosilicate (Wollastonite), mica, silica and calcium carbonate. The organic and inorganic fillers may be solid, hollow, or layered in composition and may range in size from 10 nm to 1 mm in at least one dimension.

Optionally, according to the present invention, additional fillers, thixotropes, colorants, tints and/or other materials also may be added to the adhesive composition.

Useful thixotropes that may be used include untreated fumed silica and treated fumed silica, castor wax, clay, organo clay and combinations thereof. In addition, fibers such as synthetic fibers like Aramid® fiber and Kevlar® fiber, acrylic fibers, and/or engineered cellulose fiber may also be utilized.

Useful colorants, dyes, or tints may include red iron pigment, titanium dioxide, calcium carbonate, and phthalocyanine blue and combinations thereof.

Useful fillers that may be used in conjunction with thixotropes may include inorganic fillers such as inorganic clay or silica and combinations thereof.

Exemplary other materials that may be utilized include, for example, calcium oxide and carbon black and combinations thereof.

Such fillers, if present at all, may be present in the adhesive composition in an amount of no more than 10 percent by weight based on total weight of the adhesive composition, such as no more than 8 percent by weight, such as no more than 6 percent by weight. Such fillers may be present in the adhesive composition an amount of 0 percent to 10 percent by weight based on total weight of the adhesive composition, such as 0.1 percent to 8 percent by weight, such as 0.1 percent to 6 percent by weight.

Optionally, the composition may be substantially free, or essentially free, or completely free, of platy fillers such as talc, pyrophyllite, chlorite, vermiculite, or combinations thereof.

The composition of the present invention may have a measured Tg of greater than 40° C., such as greater than 100° C., such as greater than 150° C., such as greater than 200° C. Tg values as used herein with respect to the adhesive composition of the present invention means the peak in the tan delta curve generated by Dynamic Mechanical Analysis (DMA) test using a strain of 0.01%, a frequency of 6.28 Rad/s, and a temperature ramp of 2° C./minute using a TA Instruments RSA3 Dynamic Mechanical Analyzer or other similar equipment.

The present invention also is directed to a method for treating a substrate comprising, or consisting essentially of, or consisting of, contacting at least a portion of a surface of the substrate with one of the adhesive compositions of the present invention described hereinabove. The adhesive composition may be at least partially cured to form a coating, layer or film on the substrate surface by exposure to an external energy source, as described herein.

The present invention is also directed to a method for forming a bond between two substrates for a wide variety of potential applications in which the bond between the substrates provides particular mechanical properties related to both lap shear strength and displacement. The method may comprise, or consist essentially of, or consist of, applying one of the adhesive compositions described above to a first substrate; contacting a second substrate to the composition such that the composition is located between the first substrate and the second substrate; and at least partially curing the composition by exposure to an external energy source, as described herein. For example, the adhesive composition may be applied to either one or both of the substrate materials being bonded to form an adhesive bond therebetween and the substrates may be aligned, and pressure and/or spacers may be added to control bond thickness. The composition may be applied to cleaned or uncleaned (i.e., including oily or oiled) substrate surfaces.

As stated above, the adhesive compositions of the present disclosure may form an adhesive on a substrate or a substrate surface. The adhesive composition may be applied to substrate surfaces, including, by way of non-limiting example, a vehicle body, components of an automobile frame or an airplane, parts used in or on a vehicle, and the like. The adhesive formed by the adhesive composition of the present invention provides sufficient lap shear strength and displacement. The adhesive composition may be applied to cleaned or uncleaned (i.e., including oily or oiled) substrate surfaces. It may also be applied to a substrate that has been pretreated, coated with an electrodepositable coating, coated with additional layers such as a primer, basecoat, or topcoat. An external energy source may subsequently be applied to cure the adhesive composition, such as baking in an oven.

The adhesive composition described above may be applied alone or as part of a coating system that can be deposited in a number of different ways onto a number of different substrates. The system may comprise a number of the same or different layers and may further comprise other coating compositions such as pretreatment compositions, primers, and the like. An adhesive coating, film, layer or the like is typically formed when an adhesive composition that is deposited onto the substrate is at least partially cured by methods known to those of ordinary skill in the art (e.g., by exposure to thermal heating or actinic radiation).

The adhesive composition can be applied to the surface of a substrate in any number of different ways, non-limiting examples of which include brushes, rollers, films, pellets, pressure injectors, spray guns and applicator guns.

After application to a substrate surface, the adhesive composition can be at least partially cured to form an adhesive coating, layer or film, such as using an external energy source such as an oven or other thermal means or through the use of actinic radiation. For example, the adhesive composition may be characterized as a “low bake temperature” adhesive composition that can be cured by baking and/or curing at a temperature of at least 80° C., such as at a temperature of at least 140° C., such as at least 170° C., to achieve acceptable lap shear performance and tensile elongation results. In other examples, the adhesive can be cured by baking at a temperature of no more than 250° C., such as no more than 210° C., and in some cases at a temperature of from 80° C. to 250° C., such as from 140° C. to 210° C., and for any desired time period (e.g., from 5 minutes to 24 hours) sufficient to at least partially cure the adhesive composition on the substrate(s). The skilled person understands, however, that the time of curing varies with temperature.

Also disclosed is a method for forming an adhesive on a substrate surface comprising, or consisting essentially of, or consisting of, applying a composition to at least a portion of the substrate surface (optionally an oiled, a lubricated, or an oily surface). The composition may comprise, or consist essentially of, or consist of: a resin composition comprising an epoxidized polysulfide and an epoxidized oil (e.g., an epoxidized natural oil), wherein the epoxidized polysulfide is present in the adhesive composition in a weight ratio to the epoxidized oil of 20:1 to 1:1; and an epoxy-containing compound. As used herein with respect to a substrate surface, an oiled, lubricated, or oily surface refers to a substrate surface that is lubricated or oily as a result of a manufacturing process or is pretreated with a lubricant, an oil or an oily substance.

Also disclosed is a method for forming a bond between two substrates comprising, or consisting essentially of, or consisting of, applying a composition to at least a portion of a surface of the first substrate (optionally an oiled or oily surface), such that the composition is located between the first and the second substrate (optionally an oiled or oily surface); and applying an external energy source to cure the composition. The composition may comprise, or consist essentially of, or consist of: a resin composition comprising an epoxidized polysulfide and an epoxidized oil (e.g., an epoxidized natural oil), wherein the epoxidized polysulfide is present in the adhesive composition in a weight ratio to the epoxidized oil of 20:1 to 1:1; and an epoxy-containing compound. The first and second substrates may be made of the same material or may be made of dissimilar materials. For example, a first substrate and a second substrate may be a metal and a plastic; two dissimilar plastics; a metal or a plastic and a reinforced plastic composite; or two dissimilar plastic composites.

Also disclosed are substrates and articles comprising, or consisting essentially of, or consisting of, adhesives formed from the compositions of the present invention. For example, also disclosed is a coated substrate, wherein at least a portion of a surface of the substrate is at least partially coated with a composition comprising, or consisting essentially of, or consisting of: a resin composition comprising an epoxidized polysulfide and an epoxidized oil (e.g., an epoxidized natural oil), wherein the epoxidized polysulfide is present in the adhesive composition in a weight ratio to the epoxidized oil of 20:1 to 1:1.

Also disclosed is an article comprising, or consisting essentially of, or consisting of, first and second substrates and a composition positioned therebetween and in an at least partially cured state, wherein the composition comprises, or consists essentially of, or consists of: a resin composition comprising an epoxidized polysulfide and an epoxidized oil (e.g., an epoxidized natural oil), wherein the ratio comprises a ratio of the epoxidized polysulfide to the epoxidized oil of 20:1 to 1:1; and an epoxy-containing compound.

As stated above, the present disclosure is directed to adhesive compositions that may be used to bond together two substrate materials for a wide variety of potential applications in which the bond between the substrate materials provides particular mechanical properties related to combined lap shear strength and displacement. The adhesive composition may be applied to either one or both of the substrate materials being bonded such as, by way of non-limiting example, components of a vehicle. The pieces are aligned, and pressure and/or spacers may be added to control bond thickness.

As stated above, the present disclosure also is directed to adhesive compositions that are used to coat a surface of a substrate to provide particular mechanical properties including strength and elongation. The adhesive composition may be applied to at least a portion of substrate surface, such as any of the substrates described herein.

It has been surprisingly discovered that the adhesives of the present invention, in the at least partially cured state have both a lap shear displacement at failure of at least 7 mm and a lap shear strength when cured at a low bake temperature (e.g., at least 80° C.) of greater than 13 MPa measured according to SAE J1523 as measured by an INSTRON 5567 machine in tensile mode with 45.1 mm of aluminum substrate in each grip and a nominal pull rate of 13 mm per minute.

The substrates that may be coated by the compositions of the present invention are not limited. Suitable substrates useful in the present invention include, but are not limited to, materials such as metals or metal alloys, ceramic materials such as boron carbide or silicon carbide, polymeric materials such as hard plastics including filled and unfilled thermoplastic materials or thermoset materials, or composite materials. Other suitable substrates useful in the present invention include, but are not limited to, glass or natural materials such as wood. For example, suitable substrates include rigid metal substrates such as ferrous metals, aluminum, aluminum alloys, magnesium titanium, copper, and other metal and alloy substrates. The ferrous metal substrates used in the practice of the present invention may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used. Aluminum alloys of the 1XXX, 2XXX, 3XXX, 4XXX, 5XXX, 6XXX, 7XXX, or 8XXX series as well as clad aluminum alloys and cast aluminum alloys of the A356, 1XX.X, 2XX.X, 3XX.X, 4XX.X, 5XX.X, 6XX.X, 7XX.X, or 8XX.X series also may be used as the substrate. Magnesium alloys of the AZ31B, AZ91C, AM60B, or EV31A series also may be used as the substrate. The substrate used in the present invention may also comprise titanium and/or titanium alloys of grades 1-36 including H grade variants. Other suitable non-ferrous metals include copper and magnesium, as well as alloys of these materials. Suitable metal substrates for use in the present invention include those that are used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, and industrial structures and components. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091. The substrate may comprise a composite material such as a plastic or a fiberglass composite. The substrate may be a fiberglass and/or carbon fiber composite. The compositions of the present invention are particularly suitable for use in various industrial or transportation applications including automotive, light and heavy commercial vehicles, marine, or aerospace.

Whereas specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof. All parts and percentages in the examples and throughout the specification are by weight unless indicated otherwise.

### Examples

Four adhesive composition examples (Control and A-C) were prepared from the mixture of ingredients shown in Table 1. The listed ingredients were mixed in a container using a dual asymmetric centrifugal speedmixer at the rate of 2350 rpm under laboratory ambient temperature and humidity conditions (20.56° C., 77% RH). Hand mixing with a wood tongue press was also used when necessary. The ingredients were added to the container in the order shown in Table 1.

TABLE 1

| | Control | A | B | C |
|---|---|---|---|---|
| Examples | (Wt. %) | (Wt. %) | (Wt. %) | (Wt. %) |
| Core-Shell Rubber Particles | 88.26 | 83.26 | 63.82 | 58.82 |
| in epoxy resin¹ | | | | |
| Polysulfide modified epoxy | | | 24.44 | 24.44 |
| resin² | | | | |
| Mica³ | 2.65 | 2.65 | 2.65 | 2.65 |
| Wollastonite⁴ | 2.65 | 2.65 | 2.65 | 2.65 |
| Silica⁵ | 0.40 | 0.40 | 0.40 | 0.40 |
| Castor oil polyglycidyl | | 5.00 | | 5.00 |
| ether⁶ | | | | |
| Dicyandiamide⁷ | 4.51 | 4.51 | 4.51 | 4.51 |
| Diuron⁸ | 0.40 | 0.40 | 0.40 | 0.40 |
| Ajicure PN-50⁹ | 1.13 | 1.13 | 1.13 | 1.13 |
| Total wt | 100.00 | 100.00 | 100.00 | 100.00 |

¹Kane Ace MX-153, blend of bisphenol A epoxy resin and core-shell polybutadiene rubber available from Kaneka Corporation (epoxy-containing component)
²FLEP-60, available from TORAY (epoxidized polysulfide)
³DakotaPure 3000, available from Pacer Minerals (filler)
⁴NYAD 400, available from Imerys (filler)
⁵HDK H17, available from Wacker Chemie AG (filler)
⁶Heloxy modifier 505, available from Hexion (epoxidized oil)
⁷Dyhard 100 SF, available from AlzChem (latent curing agent)
⁸DYHARD UR 200, available from AlzChem (latent curing agent)
⁹Ajicure PN-50, available from Ajinomoto Co. Inc. (latent curing agent)

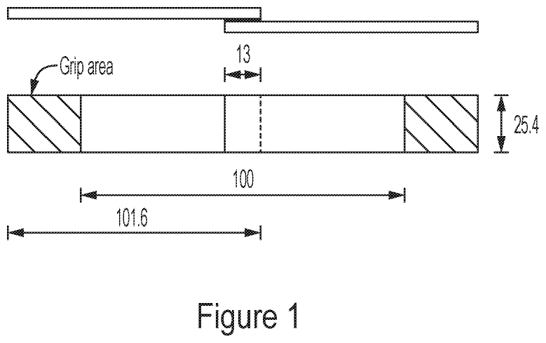

Substrate used was 6022-T3 aluminum alloy panels (from ACT) measuring 25.4 mm×101.6 mm×0.8 mm. One side of each of the aluminum panels was hand-cleaned with a light Acetone wipe. One end of each cleaned panel, including the entire width (25.4 mm) and at least 25.4 mm from one end, was coated with a thin layer of dry film lubricant Quaker DryCote® 290 to provide an oiled surface. Each adhesive composition was applied to the one end of a panel covering the full 25.4 mm width and >13 mm from one end under ambient laboratory conditions (69° F., 77% RH). Glass beads averaging 0.125 mm in diameter were mixed into the composition in an amount of 1% by weight based on total weight of the composition. A second DC-290 coated aluminum panel was then placed over the composition layer in an end-to-end fashion, resulting in a bond area of at least 25.4 mm×13 mm. See FIG. 1. Lap joints were secured with metal clips and excess composition was removed. Lap joints were baked at 150° C. for 20 minutes. The baked lap joint specimens were allowed to equilibrate at room temperature for 24 hours before tested using an INSTRON 5567 machine in tensile mode with 45.1 mm of aluminum substrate in each grip and a nominal pull rate of 13 mm per minute (in accordance with SAE J1523). Samples were tested in ambient laboratory conditions.

TABLE 2
Lap Joint Performance of Examples

| Composition | Control | A | B | C |
|---|---|---|---|---|
| Lap Shear | 10.36 ± 0.44 | 11.56 ± 0.43 | 12.73 ± 0.87 | 13.52 ± 0.54 |
| Strength (MPa) | | | | |
| Displacement | 1.37 ± 0.43 | 3.03 ± 0.76 | 5.45 ± 1.86 | 7.26 ± 1.38 |
| at Failure (mm) | | | | |

The data from Example 1 demonstrate the synergistic effect of polysulfide modified epoxy resins with an epoxidized oil in a resin composition of an adhesive composition. In example C inclusion of both polysulfide modified epoxy and epoxidized castor oil in the composition resulted in an adhesive having improved lap shear strength (13.52 MPa) and improved lap shear displacement at failure (55.8% of the overlap, in this Example, 7.26 mm), compared with the control, which did not include either a polysulfide modified epoxy resin or an epoxidized castor oil, example A, which only included epoxidized castor oil, and example B, which only included polysulfide modified epoxy resin.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. An adhesive composition, comprising:
a resin composition comprising an epoxidized polysulfide and an epoxidized oil, wherein the epoxidized polysulfide is present in the adhesive composition in a weight ratio to the epoxidized oil of 20:1 to 1:1; and
an epoxy-containing component.

2. The adhesive composition of claim 1, wherein the epoxidized polysulfide is present in the adhesive composition in an amount of 10 percent by weight to 50 percent by weight based on total weight of the adhesive composition.

3. The adhesive composition of claim 1, wherein the epoxidized polysulfide comprises a block copolymer.

4. The adhesive composition of claim 1, wherein the epoxidized oil is present in the adhesive composition in an amount of 0.5 percent by weight to 25 percent by weight based on total weight of the adhesive composition.

5. The adhesive composition of claim 1, wherein the epoxidized oil comprises an epoxidized castor oil.

6. The adhesive composition of claim 1, wherein the epoxy-containing component is present in an amount of 25 percent by weight to 89.5 percent by weight based on total weight of the adhesive composition.

7. The adhesive composition of claim 1, wherein composition further comprises elastomeric particles, a latent curing agent, an accelerator, at least one filler or combinations thereof.

8. (canceled)

9. The adhesive composition of claim 7, wherein the elastomeric particles are present in the composition in an amount of 0.5 percent by weight to 80 percent by weight based on total weight of the adhesive composition.

10. (canceled)

11. The adhesive composition of claim 7, wherein the latent curing agent comprises an encapsulated curing agent, a non-encapsulated curing agent, a blocked curing agent, or combinations thereof.

12. The adhesive composition of claim 7, wherein the latent curing agent is present in an amount of 1 percent by weight to 20 percent by weight based on total weight of the adhesive composition.

13. (canceled)

14. The adhesive composition of claim 7, wherein the accelerator comprises an encapsulated accelerator, a non-encapsulated accelerator, a blocked accelerator, or combinations thereof.

15. The adhesive composition of claim 7, wherein the accelerator is present in an amount of 0.05 percent by weight to 5 percent by weight based on total weight of the adhesive composition.

16. (canceled)

17. The adhesive composition of claim 7, wherein the at least one filler is present in an amount of 10% by weight or less based on total weight of the adhesive composition.

18-19. (canceled)

20. A substrate comprising at least one surface at least partially coated with a layer formed from the composition of claim 1.

21. The substrate of claim 20, wherein the substrate comprises an oiled or an oily substrate.

22. The coated substrate of claim 20, wherein the layer, in an at least partially cured state, has:
(a) a lap shear strength of at least 13 MPa measured according to SAE J1523 as measured by an INSTRON 5567 machine in tensile mode with 45.1 mm of aluminum substrate in each grip and a nominal pull rate of 13 mm per minute; and/or
(b) a displacement at failure of at least 7 mm.

23. An adhesive, in an at least partially cured state, having:
(a) a lap shear strength of at least 13 MPa measured according to SAE J1523 as measured by an INSTRON 5567 machine in tensile mode with 45.1 mm of aluminum substrate in each grip and a nominal pull rate of 13 mm per minute; and
(b) a displacement at failure of at least 7 mm.

24. An article, comprising:
a first substrate;
a second substrate; and
the composition of claim 1 positioned between the first and second substrates.

25. The article of claim 24, wherein at least one of the substrates comprises an oiled or an oily substrate.

26. A method of treating a substrate comprising:
contacting at least a portion of a surface of the substrate with the composition of claim 1.

27. The method of claim 26, wherein the composition is heated at a temperature of at least 80° C.
